(19) United States
(12) Patent Application Publication
(10) Pub. No.: US 2024/0372595 A1
(43) Pub. Date: Nov. 7, 2024

(54) Interference Mitigation For Full Duplex Communication

(71) Applicant: Telefonaktiebolaget LM Ericsson (PUBL), Stockholm (SE)

(72) Inventors: Ratheesh Kumar Mungara, Sundbyberg (SE); Gustav Wikström, TÄBY (SE); Jose Mairton Barros da Silva Junior, Skarpnäck (SE); Carlo Fischione, Stockholm (SE); Gabor Fodor, Hässelby (SE)

(21) Appl. No.: 18/561,000

(22) PCT Filed: May 17, 2021
(86) PCT No.: PCT/EP2021/062923

§ 371 Date: Nov. 15, 2023

(51) Int. Cl. H04B 7/06; H04B 17/345; H04L 5/14

(52) U.S. Cl. CPC H04B 7/0632; H04B 17/345; H04L 5/14

(57) ABSTRACT

Disclosed is a method for suppression, at a first radio access node, of interference caused by one or more other radio access nodes when the first radio access node and/or the other radio access nodes operate in a full duplex mode. The full duplex mode comprises simultaneous transmission and reception in a same frequency interval.

The method comprises acquiring measurements indicative of channel conditions between the one or more other radio access nodes and the first radio access node, wherein channel conditions indicate interference caused at the first radio access node by the one or more other radio access nodes.

The method also comprises selecting a set of radio access nodes from the one or more other radio access nodes based on the channel conditions between the one or more other radio access nodes and the first radio access node, and determining an uplink receive filter for suppression of interference at the first radio access node based on the channel conditions between the selected set of radio access nodes and the first radio access node.

In some embodiments, the method further comprises controlling one or more user devices served by the first radio access node to apply an uplink transmit beamforming which is based on the uplink receive filter.

Corresponding user device method, apparatuses, network node, user device, and computer program product are also disclosed.

### TECHNICAL FIELD

The present disclosure relates generally to the field of wireless communication. More particularly, it relates to interference mitigation when one or more radio access nodes operate in a full duplex (FD) mode.

### BACKGROUND

Full duplex communication, wherein a communication device (e.g., a network node) simultaneously transmit and receive in a same frequency interval, has the potential of enabling a frequency reuse factor of 1/2. This may be desirable to increase throughput and/or spectral efficiency, for example.

For a communication device operating in full duplex where the transmission and reception is simultaneous in a shared frequency interval, the receiver of the device will typically experience self-interference from the transmitter of the device. There are approaches available in the prior art for mitigation of such self-interference.

However, even with self-interference mitigation, using full duplex network nodes (e.g., radio access nodes, such as base stations) for several cells in vicinity to each other is challenging because the number of interference sources increases. For example, interference between different network nodes may become more prominent.

Therefore, there is a need for approaches to mitigate interference for full duplex communication.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for suppression, at a first radio access node, of interference caused by one or more other radio access nodes when the first radio access node and/or the other radio access nodes operate in a full duplex mode. The full duplex mode comprises simultaneous transmission and reception in a same frequency interval.

The method comprises acquiring measurements indicative of channel conditions between the one or more other radio access nodes and the first radio access node, wherein channel conditions indicate interference caused at the first radio access node by the one or more other radio access nodes.

The method also comprises selecting a set of radio access nodes from the one or more other radio access nodes based on the channel conditions between the one or more other radio access nodes and the first radio access node, and determining an uplink receive filter for suppression of interference at the first radio access node based on the channel conditions between the selected set of radio access nodes and the first radio access node.

In some embodiments, selecting the set of radio access nodes comprises one or more of: selecting the set to comprise a predefined number of radio access nodes, selecting the set to comprise radio access nodes which cause highest interference at the first radio access node among the one or more other radio access nodes, selecting the set to comprise radio access nodes which cause interference at the first radio access node that exceeds an interference threshold, and selecting the set to comprise radio access nodes which cause an accumulated interference at the first radio access node that is a defined fraction of an accumulated interference at the first radio access node caused by all of the one or more other radio access nodes.

In some embodiments, determining the uplink receive filter for the first radio access node comprises selecting the uplink receive filter based on a null space defined by the channel conditions between the selected set of radio access nodes and the first radio access node.

In some embodiments, the uplink receive filter is determined based on a vector in the null space, or as a reception code book vector which has shortest distance to the null space among available reception code book vectors.

In some embodiments, the null space is an intersection between respective null spaces defined by the channel conditions between each of the selected set of radio access nodes and the first radio access node.

In some embodiments, the method further comprises, when the intersection is an empty space, removing one or more radio access nodes from the set before determining the uplink receive filter for the first radio access node.

In some embodiments, the method further comprises controlling one or more user devices served by the first radio access node to apply an uplink transmit beamforming which is based on the uplink receive filter.

In some embodiments, acquiring measurements comprises performing the measurements.

In some embodiments, the method further comprises receiving an indication of which radio resources are suitable for performing the measurements.

In some embodiments, the method further comprises acquiring transmission particulars of the one or more other radio access nodes, wherein selecting the set of radio access nodes is further based on the transmission particulars.

In some embodiments, the transmission particulars of a radio access node are indicative of one or more of: whether the radio access node operates in a full duplex mode, whether the radio access node operates in a half duplex mode, whether the radio access node operates in a non-transmission mode, a downlink transmit beamforming of the radio access node, and a transmission pattern of the radio access node.

In some embodiments, the channel conditions are indicative of an effective channel, wherein an impact of the effective channel corresponds to an impact of one or more of: transmitter imperfections, transmitter settings, propagation channel, interference, receiver settings, and receiver imperfections.

A second aspect is a method for a user device served by a first radio access node, wherein the first radio access node applies an uplink receive filter for suppression of interference caused by one or more other radio access nodes when the first radio access node and/or the other radio access nodes operate in a full duplex mode. The full duplex mode comprises simultaneous transmission and reception in a same frequency interval.

The uplink receive filter has been based on channel conditions between a set of radio access nodes and the first radio access node, wherein channel conditions indicate interference caused at the first radio access node by the one or more other radio access nodes; the set of radio access nodes selected from the one or more other radio access nodes based on the channel conditions between the one or more other radio access nodes and the first radio access node.

The method comprises receiving a control signal indicative of one or more of: the uplink receive filter and an uplink transmit beamforming which is based on the uplink receive filter.

In some embodiments, wherein the control signal is indicative of the uplink receive filter, the method may further comprise determining the uplink transmit beamforming based on the uplink receive filter.

In some embodiments, determining the uplink transmit beamforming based on the uplink receive filter comprises selecting the uplink transmit beamforming such that a composite channel between the user device and the first radio access node fulfills a channel criterion, wherein the composite channel is defined by a combination of at least the uplink transmit beamforming, a propagation channel between the user device and the first radio access node, and the uplink receive filter.

In some embodiments, the uplink transmit beamforming is selected as an eigenvector corresponding to a largest eigenvalue of a combination of the propagation channel between the user device and the first radio access node and the uplink receive filter.

In some embodiments, determining the uplink transmit beamforming is further based on an interference condition.

In some embodiments, the method further comprises adjusting a power control setting based on the uplink receive filter and/or the uplink transmit beamforming.

A third aspect is a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

A fourth aspect is an apparatus for suppression, at a first radio access node, of interference caused by one or more other radio access nodes when the first radio access node and/or the other radio access nodes operate in a full duplex mode. The full duplex mode comprises simultaneous transmission and reception in a same frequency interval.

The apparatus comprises controlling circuitry configured to cause acquisition of measurements indicative of channel conditions between the one or more other radio access nodes and the first radio access node, wherein channel conditions indicate interference caused at the first radio access node by the one or more other radio access nodes.

The controlling circuitry is also configured to cause selection of a set of radio access nodes from the one or more other radio access nodes based on the channel conditions between the one or more other radio access nodes and the first radio access node, and determination of an uplink receive filter for suppression of interference at the first radio access node based on the channel conditions between the selected set of radio access nodes and the first radio access node.

A fifth aspect is a network node comprising the apparatus of the fourth aspect.

A sixth aspect is an apparatus for a user device served by a first radio access node, wherein the first radio access node applies an uplink receive filter for suppression of interference caused by one or more other radio access nodes when the first radio access node and/or the other radio access nodes operate in a full duplex mode. The full duplex mode comprises simultaneous transmission and reception in a same frequency interval.

The uplink receive filter has been based on channel conditions between a set of radio access nodes and the first radio access node, wherein channel conditions indicate interference caused at the first radio access node by the one or more other radio access nodes; the set of radio access nodes selected from the one or more other radio access nodes based on the channel conditions between the one or more other radio access nodes and the first radio access node.

The apparatus comprises controlling circuitry configured to cause reception of a control signal indicative of one or more of: the uplink receive filter and an uplink transmit beamforming which is based on the uplink receive filter.

A seventh aspect is a user device comprising the apparatus of the sixth aspect.

In some embodiments, any of the above aspects may additionally have features identical with or corresponding to any of the various features as explained above for any of the other aspects.

An advantage of some embodiments is that approaches are provided for mitigation of interference for full duplex communication.

An advantage of some embodiments is that full duplex communication is enabled or improved in cellular systems (e.g., while having high frequency reuse—low frequency reuse factor—between cells).

An advantage of some embodiments is that increased frequency reuse is enabled (e.g., compared to a half duplex system and/or compared to a full duplex system having a high reuse factor).

An advantage of some embodiments is that increased spectral efficiency is achieved (e.g., compared to a half duplex system and/or compared to a full duplex system having a high reuse factor).

An advantage of some embodiments is increased system capacity.

An advantage of some embodiments is that end-to-end latency may be reduced (e.g., due to increased user throughput).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic drawing illustrating an example scenario where some embodiments may be applicable;

FIG. 2 is a flowchart illustrating example method steps according to some embodiments;

FIG. 3 is a signaling diagram illustrating example signaling according to some embodiments;

FIG. 4 is a signaling diagram illustrating example signaling according to some embodiments;

FIG. 5 is a schematic block diagram illustrating an example apparatus according to some embodiments;

FIG. 6 is a schematic block diagram illustrating an example apparatus according to some embodiments; and

FIG. 7 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

The term communication device is meant to encompass network nodes and/or user devices. The term network node is meant to encompass any suitable radio access node (e.g., base station, NodeB, gNB, etc.) and/or any suitable control node for one or more radio access nodes (e.g., a server node and/or a node for cloud based processing). The term user device is meant to encompass any suitable communication device which is not a network node (e.g., a user equipment, UE). The term wireless system is meant to encompass any suitable cellular communication systems.

When full duplex communication is referred to herein, it is meant to be understood as simultaneous transmission and reception by a communication device in a same frequency interval.

Traditional wireless systems are typically based on that communication devices (user devices and network nodes) operate in half duplex, where transmission and reception are separated in at least one communication dimension (e.g., time and/or frequency interval).

Neighboring network nodes may operate in a same frequency interval or in different frequency intervals, where the frequency intervals may, for example, be frequency bands. The frequency reuse factor indicates to what extent a frequency interval may be utilized for communication in a wireless system. A relatively low frequency reuse factor indicates that the frequency interval is utilized to a relatively high extent. Wireless systems have evolved from relatively high frequency reuse factors to frequency reuse factor one (i.e., neighboring network nodes operate using the same frequency interval in the same link direction—uplink (UL) or downlink (DL)).

If the reuse factor could be further decreased, the communication capacity of a wireless system may increase. For example, using full duplex communication with neighboring network nodes operating using the same frequency interval in both link directions (UL and DL), could potentially result in frequency reuse factor of 1/2.

As already mentioned, a communication device operating in full duplex where the transmission and reception is simultaneous in a shared frequency interval, the receiver of the device will typically experience self-interference from the transmitter of the device. There are approaches available in the prior art for mitigation of such self-interference, which makes full duplex worth consideration. However, even with self-interference mitigation, using full duplex network nodes is challenging because it typically increases interference.

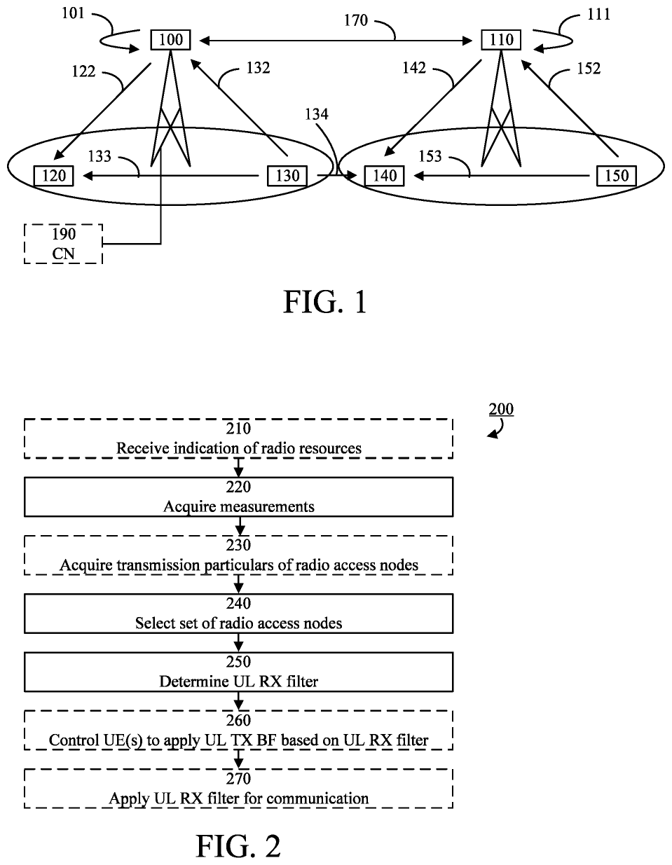

FIG. 1 schematically illustrates an example scenario where two radio access nodes (e.g., base stations, BS) 100, 110 of a wireless system operate in full duplex mode. Thus, the radio access node 100 is configured to—simultaneously in a same frequency interval—transmit signals to user device(s) (e.g., user equipments, UE) 120 in the downlink as illustrated by 122 and receive signals from user device(s) 130 in the uplink as illustrated by 132. Correspondingly, the radio access node 110 is configured to—simultaneously in a same frequency interval—transmit signals to user device(s) 140 in the downlink as illustrated by 142 and receive signals from user device(s) 150 in the uplink as illustrated by 152.

In addition to typical interference between and within cells experienced for half duplex operation, full duplex communication gives rise to self-interference and cross link interference (CLI). The respective self-interference at the radio access nodes 100, 110 is illustrated by 101, 111 in FIG. 1. The CLI includes interference experienced at receiving user device(s) 120, 140 and caused by transmitting user device(s) 130, 150. This type of CLI may be termed UE-to-UE CLI and is represented in FIG. 1 by 133, 153 for UE-to-UE CLI within cells and by 134 for UE-to-UE CLI between cells. The CLI also includes interference between cells that the radio access nodes 100, 110 causes to each other. This type of CLI may be termed BS-to-BS CLI and is represented in FIG. 1 by 170.

The UE-to-UE CLI may typically be considered less cumbersome than the BS-to-BS CLI (e.g., since users typically use lower transmission power than radio access nodes, and/or since uplink power control is typically used to regulate the signal-to-noise ratio, SNR). Thus, it is typically desirable to mitigate the BS-to-BS CLI.

In the following, embodiments will be described where approaches to mitigate (e.g., suppress) interference (e.g., BS-to-BS CLI) for full duplex communication are presented. With reference to FIG. 1, such approaches may, for example, be applied by one or more of the radio access nodes 100, 110, and/or by a control node (CN) 190, and/or by one or more of the user devices 120, 130, 140, 150.

FIG. 2 illustrates an example method 200 according to some embodiments. The method 200 may be performed by a network node (e.g., a radio access node or a control node).

The method 200 is for suppression, at a first radio access node (e.g., victim BS), of interference caused by one or more other radio access nodes (e.g., interfering BS(s)) when the first radio access node and/or the other radio access nodes operate in a full duplex mode (simultaneous transmission and reception in a same frequency interval).

Thus, there are several scenarios where the method 200 may be applicable; when the victim BS and at least one of the interfering BS(s) operate in full duplex mode, when the victim BS operates in full duplex mode and the interfering BS(s) operate in half duplex mode, and when the victim BS operates in half duplex mode and at least one of the interfering BS(s) operate in full duplex mode.

The method 200 may be performed once for the first radio access node (e.g., at deployment of the first radio access node), or repeatedly (e.g., when a potentially interfering radio access node is deployed in the vicinity of the first radio access node, and/or at periodical time intervals, and/or triggered by an event such as, for example, low signal-to-interference ratio (SIR) detected at the first radio access node).

In step 220, measurements (e.g., channel estimation measurements) are acquired which are indicative of channel conditions between the one or more other radio access nodes and the first radio access node.

Step 220 may comprise performing the measurements (e.g., when the method 200 is performed by the first radio access node). In this case, the method 200 may further comprise receiving an indication of which radio resources are suitable for performing the measurements (e.g., which radio resources are used for reference signals, such as—for example—channel state information reference signals, CSI-RS, demodulation reference signals, DMRS, sounding reference signals, SRS, etc.), as illustrated by optional step 210. The indication may be received from the one or more other radio access nodes, or from a control node, for example.

Alternatively, step 220 may comprise receiving a signal indicating results of measurements (e.g., when the method 200 is performed by a control node and the measurements are performed by the first radio access node and/or one or more other radio access nodes).

The channel conditions indicate interference caused at the first radio access node by the one or more other radio access nodes. For example, the channel conditions may indicate one or more of: spatial characteristics of the interference, frequency distribution of the interference, time occurrence of the interference, and power level of the interference.

In typical embodiments, the channel conditions are indicative of an effective channel. The effective channel may be defined as specifying the collective impact of one or more of: transmitter imperfections, transmitter settings, propagation channel, interference, receiver settings, and receiver imperfections. In some embodiments, the channel conditions include a channel state, which may be parametrized by one or more of: channel state information (CSI), signal-to-interference ratio (SIR), interference strength (e.g., measured via received signal strength indicator, RSSI, or other received power metric), etc.

In step 240, a set [symbol] of radio access nodes is selected from the one or more other radio access nodes based on the channel conditions.

The channel conditions used for the selection in step 240 may comprise one or more of: instantaneous channel conditions acquired in step 220, statistical (e.g., filtered, averaged, etc.) versions of the instantaneous channel conditions acquired in step 220, and channel condition statistics (e.g., determined by a control node) which is based on the instantaneous channel conditions acquired in step 220 as well as instantaneous channel conditions acquired through measurements of radio access nodes other than the first radio access node.

Step 240 may comprise selecting the set to comprise a predefined number of radio access nodes. In some embodiments, the predefined number is a specific number (e.g., one, two, three, or a higher number). In some embodiments, the predefined number is defined by a range of numbers having a lowest number (e.g., one, two, three, or a higher number) and/or a highest number (e.g., one, two, three, or a higher number).

Alternatively, or additionally, step 240 may comprise selecting the set to comprise one or more radio access nodes which cause highest interference (e.g., has one or more of: highest received power, lowest SIR, lowest CSI, etc.) at the first radio access node among the one or more other radio access nodes.

Alternatively, or additionally, step 240 may comprise selecting the set to comprise one or more (e.g., all) radio access nodes which cause interference at the first radio access node that exceeds an interference threshold value (e.g., in terms of one or more of: received power, SIR, CSI, etc.).

Alternatively, or additionally, step 240 may comprise selecting the set to comprise radio access nodes which cause an accumulated interference at the first radio access node that is a defined fraction of an accumulated interference at the first radio access node caused by all of the one or more other radio access nodes (e.g., in terms of one or more of: received power, SIR, CSI, etc.). Example suitable fraction values are in the range 50-100%, for example. In some embodiments, a lowest allowed fraction is used for the selection, and step 240 may comprise selecting the set to comprise radio access nodes which cause an accumulated interference at the first radio access node that is higher than the lowest allowed fraction of the accumulated interference at the first radio access node caused by all of the one or more other radio access nodes

In some embodiments, the set [symbol] comprises only the radio access nodes selected from the one or more other radio access nodes. In other embodiments, the set [symbol] may also comprise the first radio access node (thereby including self-interference in the suppression). One possibility for the latter embodiments is to always let the set [symbol] comprise the first radio access node. Another possibility for the latter embodiments is to select the set [symbol] from a collection of the first radio access node and the one or more other radio access nodes, based on the channel conditions for the self-interference and the channel conditions between the one or more other radio access nodes and the first radio access node (i.e., applying the channel condition selection criteria used for the one or more other radio access nodes also to the channel condition for the self-interference of the first radio access node).

In some embodiments, the selection of the set [symbol] in step 240 is further based on transmission particulars of the radio access nodes.

In such embodiments, the method 200 may further comprise acquiring transmission particulars of the one or more other radio access nodes, as illustrated by optional step 230. For example, the transmission particulars may be acquired via reception of explicit signaling from the one or more other radio access nodes and/or from a control node. Alternatively, or additionally, the transmission particulars may be acquired via implicit statistics derived by measurements.

Example transmission particulars of a radio access node may be indicative of one or more of: whether the radio access node is active, whether the radio access node operates in a full duplex mode, whether the radio access node operates in a half duplex mode, whether the radio access node operates in a non-transmission mode, whether the radio access node has DL data for transmission, a downlink transmit beamforming of the radio access node, and a transmission pattern of the radio access node (e.g., indicating a pattern for one or more of the above pieces of information).

For example, when a radio access node is not active, operates in a non-transmission mode, has no DL data for transmission, and/or uses a downlink transmit beamforming that has little energy directed towards the first radio access node, that radio access node may be removed from consideration in the selection of step 240.

Alternatively, or additionally, a radio access node may be selected with higher probability when it operates in a full duplex mode that when it operates in a half duplex mode.

In step 250, an uplink receive (UL RX) filter U_{b1} is determined for suppression of interference at the first radio access node indexed b1. The uplink receive filter may implement reception beamforming and/or may use a spatial receiver setting (e.g., based on a receiver code book).

The determination is based on the channel conditions between the selected set [symbol] of radio network nodes and the first radio access node.

The channel conditions used for the determination in step 250 may comprise one or more of: instantaneous channel conditions acquired in step 220, statistical (e.g., filtered, averaged, etc.) versions of the instantaneous channel conditions acquired in step 220, and channel condition statistics (e.g., determined by a control node) which is based on the instantaneous channel conditions acquired in step 220 as well as instantaneous channel conditions acquired through measurements of radio access nodes other than the first radio access node.

For example, the determination in step 250 may aim to minimize (or at least reduce) the interference at the first radio access node caused by the radio access nodes of the selected set [symbol] .

In some embodiments, the uplink receive filter for the first radio access node may be determined by selection based on a null space defined by the channel conditions for the selected set [symbol] . A suitable null space is the intersection between respective null spaces defined by the channel conditions for the radio access nodes in the selected set [symbol] .

For example, the uplink receive filter may be determined based on a vector in the null space (e.g., as a vector in the null space or as an approximation of a vector in the null space).

For example, when the null space comprises several vectors (e.g., if the null space extends in more than one dimension and/or if the intersection between null spaces comprises multiple vectors), one of the vectors may be selected as the uplink receive filter based on a selection criterion. In one example, the vector that maximizes the SNR with respect to the intended transmitter is selected. On another example, the vector is with smallest Euclidian distance to the maximum ratio combiner (MRC) vector is selected.

Alternatively, or additionally, the uplink receive filter may be determined as a reception code book vector (e.g., one which has shortest distance to the null space among available reception code book vectors).

In some embodiments, the method 200 may further comprise, when the intersection (or any of the null spaces) is an empty space, removing one or more radio access nodes from the set [symbol] before determining the uplink receive filter. For example, radio access nodes which cause lowest interference at the first radio access node among the radio access nodes of the set [symbol] may be removed.

The terms null space, empty space, and intersection may be in accordance with typical mathematical definitions (e.g., assuming that the channel conditions are expressed as a matrix).

It should be noted that other approaches are possible for determining the UL RX filter based on the channel conditions between the selected set [symbol] of radio access nodes and the first radio access node. For example, instead of a vector in the null space, the eigenvector of the smallest eigenvalue for the channel conditions of the selected set [symbol] may be used.

As illustrated by optional step 260, the method 200 may further comprise controlling one or more user devices indexed uj and served by the first radio access node to apply an uplink transmit beamforming (UL TX BF) Vᵤⱼ which is based on the uplink receive filter U_{b1}. The uplink transmit beamforming may implement transmission beamforming and/or may use a spatial transmitter setting (e.g., based on a transmitter code book).

The control of step 260 may, for example, be implemented by signaling to the user device(s) in DL control information (DCI).

The control may be achieved by provision of an indication of respective UL TX BF to the user device(s), wherein the respective UL TX BF has been determined by the first radio access node, or by a control node, based on the UL RX filter.

Alternatively, the control may be achieved by provision of an indication of the UL RX filter to the user device(s), so that the user device(s) can determine respective UL TX BF based on the UL RX filter.

According to some embodiments, an indication of several possible UL RX filters determined in step 250 is provided to the user device(s) in step 260. Then, the user device(s) may select one of the possible UL RX filters and report the selection to the first radio access node for application therein, or the user device(s) may determine a preferred one of the possible UL RX filters and report the preference to the first radio access node for final selection and application therein.

The method 200 may further comprise using the UL RX filter determined in step 250 for communication, as illustrated by optional step 270. The communication is full duplex for at least one of the first radio access node and the one or more other radio access nodes of the set [symbol] . Thus, the communication may be full duplex or half duplex for the first radio access node, as already explained above.

Thus, some embodiments provide a method 200 for a wireless system where at least some nodes operate in full duplex. The method 200 identifies dominating BS-to-BS interference (compare with step 240 of FIG. 2), and provides for suppression of such interference by application of an uplink receiver filter at the victim BS, wherein the uplink receive filter is determined based on channel measurements on interfering BSs (compare with step 250 of FIG. 2). Thereby, blockage of the uplink signal at the BS receiver may be avoided, which may improve the overall system performance for the full duplex system.

An advantage of some embodiments is that full duplex communication is enabled in cellular systems while preserving a low frequency reuse factor across neighboring cells. Thereby, increased frequency reuse (decreased frequency reuse factor) is enabled compared to half duplex systems and/or compared to full duplex systems employing a high reuse factor.

An advantage of some embodiments is that spectral efficiency may be improved (e.g., increased) compared to half duplex systems and/or compared to full duplex systems employing a high reuse factor.

An advantage of some embodiments is that system capacity may be increased.

An advantage of some embodiments is that end-to-end latency may be reduced due to increased user throughput.

An example will now be presented to illustrate application of the principles according to some embodiments.

In this example, a full duplex multicell network will be considered, where radio access nodes in the form of gNBs indexed bk operate in full duplex mode while UEs indexed uj are equipped with half duplex transceivers. Each gNB has N_{b} antennas and each UE is equipped with Nᵤ antennas.

A scenario is considered in which each gNB simultaneously transmits a signal stream to a UE in the downlink and receives another signal stream from a different UE in the uplink, where transmission and reception is on the same time-frequency signaling resource. In practice, multiple UEs can be multiplexed for each link direction across spatial and/or frequency dimensions such that there is no inter-stream interference.

The downlink signal received by UE(s) may be subject to UE-to-UE interference emanating from UE(s) transmitting in the uplink (compare with interference 134, 153 for user device 140 in FIG. 1), as well as to BS-to-UE interference from neighboring cell(s). The transmit power level of UEs is not dominating compared to that of gNBs. Therefore, the UE-to-UE interference may be treated as a negligible performance limiting factor at downlink receiving UEs.

The uplink signal received by gNB(s) may be subject to self-interference (compare with interference 101 for radio access node 100 in FIG. 1), to UE-to-BS interference from UE(s) transmitting in the uplink in neighboring cell(s), as well as to BS-to-BS interference emanating from downlink transmissions in neighboring cell(s) (compare with interference 170 for radio access node 100 in FIG. 1). Since the gNB antennas are typically mounted at an elevated location and transmitting at relatively high power compared to that of the UE(s), the BS-to-BS interference, and possibly the self-interference, will typically dominate.

A model of the signal observed at a gNB indexed b1, when receiving an uplink signal from a UE indexed u1, may be expressed as:

$${y}_{b 1} = \sqrt{{P}_{u 1} {G}_{b} {L}_{u 1 , b 1}} {H}_{u 1 , b 1} {V}_{u 1} {s}_{u 1} + {\sum }_{j} \sqrt{{P}_{u j} {G}_{b} {L}_{uj , b 1}} {H}_{uj , b 1} {V}_{u j} {s}_{u j} + {\sum }_{bk ∈ 𝒦} \sqrt{{P}_{b} {G}_{b} {G}_{b} {L}_{bk , b 1}} {H}_{bk , b 1} {V}_{b {k}^{S} b k} + {\sum }_{bk ∉ 𝒦} \sqrt{{P}_{b} {G}_{b} {G}_{b} {L}_{b k , b 1}} {H}_{bk , b 1} {V}_{b {k}^{S} b k} + {z}_{b 1} ,$$

where the first term represents the desired uplink signal, the second term represents UE-to-BS interference (from own cell and/or other cell), the third term represents BS-to-BS interference for the set [symbol] , the fourth term represents BS-to-BS interference for radio access nodes that are not in the set [symbol] , and the fifth term represents noise.

As elaborated on earlier (compare with step 240 of FIG. 2), [symbol] may, for example, represent a set of gNBs which have line-of-sight, or otherwise a very strong, link with respect to gNB b1.

Pᵤⱼ denotes the transmit power of UE uj, G_{b} denotes the antenna gain of any gNB, L_{uj,b1} denotes the large-scale path gain between UE uj and gNB b1, H_{uj,b1} denotes the small-scale fading component between UE uj and gNB b1, Vᵤⱼ denotes the transmit precoder at UE uj, and sᵤⱼ denotes the data symbol transmitted by UE uj.

P_{b} denotes the transmit power of any gNB, L_{bk,b1} denotes the large-scale path gain between gNB bk and gNB b1, H_{bk,b1} denotes the small-scale fading component between gNB bk and gNB b1, V_{bk} denotes the transmit precoder at gNB bk, and s_{bk} denotes the data symbol(s) transmitted by gNB bk.

The noise may include residual self-interference and/or noise from other sources. The residual self-interference is typically a function of the transmit-receive isolation E and the BS transmit power P_{b}, and when the noise z_{b1} at gNB b1 represents noise including residual self-interference, it may be modeled as additive white Gaussian noise with variance (P_{N}+P_{b}/ε) where P_{N} is the power of noise from other sources.

According to some embodiments, the received signal at gNB b1 is processed by applying a spatial receive filter, denoted by U_{b1} (compare with the UL RX filter determined in step 250 of FIG. 2). One aim of some embodiments presented herein is to suppress dominating BS-to-BS interference. This may be to avoid blocking of the uplink receiver and/or to improve the overall system performance, for example. Thus, in some embodiments, it is desirable to maximize the signal component |U_{b1}^{H}H_{u1,b1}Vᵤ₁| and suppress the interference; preferably so that U_{b1}^{H}H_{bk,b1}V_{bk}=0, ∇bk∈ [symbol] .

The network may inform the gNB b1 regarding which measurement resources are suitable for acquiring CSI values (and/or other relevant channel characteristic values) with respect to interfering gNBs bk (compare with step 210 of FIG. 2).

After acquiring the CSI values (compare with step 220 of FIG. 2), the gNB b1 may determine the receive filter, for suppression on relation to the set [symbol] based on the CSI values (compare with step 250), as U_{b1}∈NS([{H_{bk,b1} [symbol] ]), where NS([{H_{bk,b1} [symbol] ]) is the intersection between the respective null spaces of H_{bk,b1} for each bk∈ [symbol] . Alternatively, the receive filter may be determined as U_{b1}∈NS([{H_{bk,b1}V_{bk} [symbol] ]).

The determined U_{b1} may be indicated to uplink transmitting UE(s) u1 associated with gNB b1 (compare with step 260 of FIG. 2) for determination of a suitable uplink transmit precoder Vᵤ₁. The indication may, for example, be in the form of a set of matrix weights communicated to the UE in a data message, or in the form of a code book index communicated to the UE in a data or control message. In some embodiments, the uplink transmit precoder Vᵤ₁ is determined by the gNB b1, and indicated to the UE(s) u1 (e.g., in an UL grant message).

For example, a suitable uplink transmit precoder may reduce interference caused to other UE(s) and/or may maximize the signal component |U_{b1}^{H}H_{u1,b1}Vᵤ₁|, or at least provide the signal component at an acceptable level (e.g., above a threshold value). The eigenvector corresponding to the maximum eigenvalue of the effective channel U_{b1}^{H}H_{u1,b1} is one example that provides a suitable uplink transmit precoder.

It should be noted that there are numerous alternatives to the above-presented approaches for determination of U_{b1} and Vᵤ₁. For example, approaches involving maximum ratio combining may be applied for determination of Vᵤ₁, and/or approaches involving minimum mean square error (MMSE) may be applied for determination of U_{b1}.

It may be noted that the cancellation as disclosed herein need not rely on successive interference cancellation, nor on a central fronthaul to coordinate exchange of information between the gNBs.

A method for a user device (e.g., complementing the method 200 for a network node) will now be described. The method is for a user device served by a first radio access node, wherein the first radio access node applies an uplink receive filter U_{b1} for suppression of interference caused by one or more other radio access nodes when the first radio access node and/or the other radio access nodes operate in a full duplex mode. The uplink receive filter has been determined as elaborated on above (compare with step 250 of FIG. 2).

The method may comprise receiving a control signal indicative of the uplink receive filter U_{b1}, and determining an uplink transmit beamforming V₁ based on the uplink receive filter. Alternatively, the method may comprise receiving a control signal indicative of the uplink transmit beamforming Vᵤ₁, wherein the uplink transmit beamforming Vᵤ₁ is determined by the network node based on the uplink receive filter U_{b1}. Either of such receptions may correspond to the control of user device(s) described earlier herein (compare with step 260 of FIG. 2).

Regardless of whether the determination of the uplink transmit beamforming Vᵤ₁ based on the uplink receive filter U_{b1} is performed by the user device or a network node, it may comprise selecting the uplink transmit beamforming such that a composite channel (e.g., defined by a combination of at least the uplink transmit beamforming, a propagation channel between the user device and the first radio access node, and the uplink receive filter) between the user device and the first radio access node fulfills a channel criterion.

Any suitable channel criterion may be used. For example, the channel criterion may comprise that the desired signal component |U_{b1}H_{u1,b1}Vᵤ₁| exceeds a signal threshold value and/or that the interference is suppressed such that [symbol] U_{b1}^{H}H_{bk,b1}V_{bk} does not exceed an interference threshold value.

For example, the uplink transmit beamforming may be selected as an eigenvector corresponding to a largest eigenvalue of a combination of the propagation channel between the user device and the first radio access node and the uplink receive filter.

The method may further comprise using the determined UL TX BF determined for communication (compare with step 270 of FIG. 2).

In some embodiments, the method also comprises adjusting a power control setting based on the uplink receive filter and/or the uplink transmit beamforming. The purpose of the adjustment may, for example, be to provide a trade-off between received power for the desired signal at the first radio access node and interference caused by the user device.

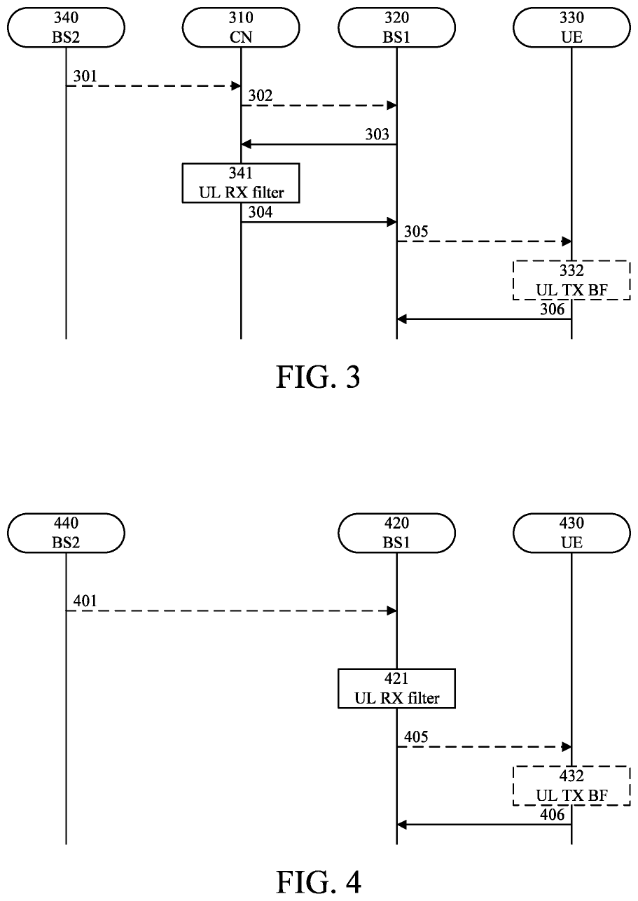

FIG. 3 illustrates example signaling according to some embodiments, between a control node (CN) 310, a first base station (BS1; e.g., the first radio access node) 320, a second base station (BS2; e.g., one of the other radio access nodes) 340, and a user equipment (UE; e.g., a user device) 330. FIG. 3 may be seen as exemplifying a scenario where at least part of the method 200 of FIG. 2 is performed by a control node (e.g., CN 310).

CN 310 may receive an indication 301 from BS2 340 of which radio resources are suitable for measurements (compare with step 210 of FIG. 2). The indication 301 may be forwarded to BS1 320 as illustrated by 302, and BS1 320 may perform channel condition measurements in relation to BS2 340.

Results of the measurements are sent by BS1 320 to CN 310 as illustrated by 303 (compare with step 220 of FIG. 2). Based on the measurements, CN 310 selects the set [symbol] (compare with step 240 of FIG. 2) and determines the UL RX filter as illustrated by 341 (compare with step 250 of FIG. 2).

The determined UL RX filter is communicated to BS1 320 as illustrated by 304, and relayed to the UE 330 as illustrated by 305 (compare with step 260 of FIG. 2). Based on the UL RX filter, the UE 330 may determine an UL TX BF as illustrated by 332.

The UL TX BF and the UL RX filter are applied in communication as illustrated by 306 (compare with step 270 of FIG. 2).

FIG. 4 illustrates example signaling according to some embodiments, between a first base station (BS1; e.g., the first radio access node) 420, a second base station (BS2; e.g., one of the other radio access nodes) 440, and a user equipment (UE; e.g., a user device) 430. FIG. 4 may be seen as exemplifying a scenario where at least part of the method 200 of FIG. 2 is performed by a first radio access node (e.g., BS1 420).

BS1 420 may receive an indication 401 from BS2 440 of which radio resources are suitable for measurements (compare with step 210 of FIG. 2), and BS1420 may perform channel condition measurements in relation to BS2 440 (compare with step 220 of FIG. 2).

Based on the measurements, BS1 420 selects the set [symbol] (compare with step 240 of FIG. 2) and determines the UL RX filter as illustrated by 421 (compare with step 250 of FIG. 2).

The determined UL RX filter may be communicated to the UE 430 as illustrated by 405 (compare with step 260 of FIG. 2). Based on the UL RX filter, the UE 430 may determine an UL TX BF as illustrated by 432.

The UL TX BF and the UL RX filter are applied in communication as illustrated by 406 (compare with step 270 of FIG. 2).

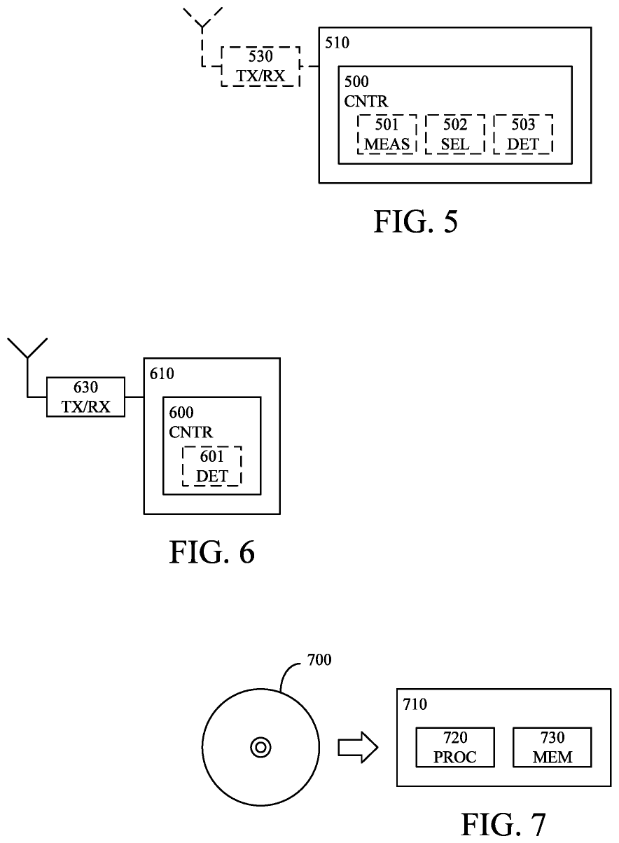

FIG. 5 schematically illustrates an example apparatus 510 according to some embodiments. The apparatus 510 may be comprisable (e.g., comprised) in a network node (e.g., a first radio access node or a control node). For example, the apparatus 510 may be configured to cause performance of (e.g., perform) one or more of the method steps as described in connection with FIG. 2.

The apparatus 510 is for suppression, at a first radio access node, of interference caused by one or more other radio access nodes when the first radio access node and/or the other radio access nodes operate in a full duplex mode. As already mentioned, full duplex mode comprises simultaneous transmission and reception in a same frequency interval.

The apparatus 510 comprises a controller (CNTR; e.g., controlling circuitry or a control module) 500.

The controller 500 is configured to cause acquisition of measurements indicative of channel conditions between the one or more other radio access nodes and the first radio access node, wherein channel conditions indicate interference caused at the first radio access node by the one or more other radio access nodes (compare with step 220 of FIG. 2).

To this end, the controller 500 may comprise, or be otherwise associated with (e.g., connectable, or connected, to) a measurer (MEAS; e.g., measuring circuitry or a measurement module) 501. The measurer 501 may be configured to perform the measurements.

Alternatively, or additionally, the controller 500 may comprise, or be otherwise associated with (e.g., connectable, or connected, to) a transmitter (TX; e.g., transmitting circuitry or a transmission module), illustrated in FIG. 5 as part of a transceiver (TX/RX) 530. The transmitter may be configured to send a control signal to the first radio access node to cause performance the measurements.

Yet alternatively, or additionally, the controller 500 may comprise, or be otherwise associated with (e.g., connectable, or connected, to) a receiver (RX; e.g., receiving circuitry or a reception module), illustrated in FIG. 5 as part of the transceiver (TX/RX) 530. The receiver may be configured to receive the measurements from the first radio access node.

The controller 500 is configured to cause selection of a set of radio access nodes from the one or more other radio access nodes based on the channel conditions between the one or more other radio access nodes and the first radio access node (compare with step 240 of FIG. 2).

To this end, the controller 500 may comprise, or be otherwise associated with (e.g., connectable, or connected, to) a selector (SEL; e.g., selecting circuitry or a selection module) 502. The selector 502 may be configured to perform the selection.

The controller 500 is configured to cause determination of an uplink receive filter for suppression of interference at the first radio access node based on the channel conditions between the selected set of radio access nodes and the first radio access node (compare with step 250 of FIG. 2).

To this end, the controller 500 may comprise, or be otherwise associated with (e.g., connectable, or connected, to) a determiner (DET; e.g., determining circuitry or a determination module) 503. The determiner 503 may be configured to determine the uplink receive filter.

The controller 500 may also be configured to cause control (e.g., via the transceiver 530) of one or more user devices served by the first radio access node to apply an uplink transmit beamforming which is based on the uplink receive filter (compare with step 260 of FIG. 2).

The controller 500 may also be configured to cause application (e.g., in the transceiver 530) of the uplink receive filter during communication (compare with step 270 of FIG. 2).

FIG. 6 schematically illustrates an example apparatus 610 according to some embodiments. The apparatus 610 may be comprisable (e.g., comprised) in a user device (e.g., a UE). For example, the apparatus 610 may be configured to cause performance of (e.g., perform) one or more of the method steps as described for user devices earlier herein.

The apparatus 610 is for a user device served by a first radio access node, wherein the first radio access node applies an uplink receive filter for suppression of interference caused by one or more other radio access nodes when the first radio access node and/or the other radio access nodes operate in a full duplex mode as described above.

The apparatus 610 comprises a controller (CNTR; e.g., controlling circuitry or a control module) 600.

The controller 600 is configured to cause reception of a control signal indicative of one or more of: the uplink receive filter and an uplink transmit beamforming which is based on the uplink receive filter.

To this end, the controller 600 may comprise, or be otherwise associated with (e.g., connectable, or connected, to) a receiver (RX; e.g., receiving circuitry or a reception module), illustrated in FIG. 6 as part of the transceiver (TX/RX) 630. The receiver may be configured to receive the control signal.

The controller 600 may also be configured to cause determination of an uplink transmit beamforming based on the uplink receive filter.

To this end, the controller 600 may comprise, or be otherwise associated with (e.g., connectable, or connected, to) a determiner (DET; e.g., determining circuitry or a determination module) 601. The determiner 601 may be configured to determine the uplink transmit beamforming.

The controller 600 may also be configured to cause application (e.g., in the transceiver 630) of the uplink transmit beamforming during communication.

It should be noted that method steps otherwise described herein may be equally applicable (mutatis mutandis) in relation to the apparatus 510 and/or the apparatus 610, even if not explicitly described in connection thereto.

The described embodiments and their equivalents may be realized in software or hardware or a combination thereof. The embodiments may be performed by general purpose circuitry.

Examples of general purpose circuitry include digital signal processors (DSP), central processing units (CPU), co-processor units, field programmable gate arrays (FPGA) and other programmable hardware. Alternatively, or additionally, the embodiments may be performed by specialized circuitry, such as application specific integrated circuits (ASIC). The general purpose circuitry and/or the specialized circuitry may, for example, be associated with or comprised in an apparatus such as a user device or a network node.

Embodiments may appear within an electronic apparatus (such as a user device or a network node) comprising arrangements, circuitry, and/or logic according to any of the embodiments described herein. Alternatively, or additionally, an electronic apparatus (such as a user device or a network node) may be configured to perform methods according to any of the embodiments described herein.

According to some embodiments, a computer program product comprises a tangible, or non-tangible, computer readable medium such as, for example a universal serial bus (USB) memory, a plug-in card, an embedded drive or a read only memory (ROM). FIG. 7 illustrates an example computer readable medium in the form of a compact disc (CD) ROM 700. The computer readable medium has stored thereon a computer program comprising program instructions. The computer program is loadable into a data processor (PROC; e.g., data processing circuitry or a data processing unit) 720, which may, for example, be comprised in a user device or a network node 710. When loaded into the data processor, the computer program may be stored in a memory (MEM) 730 associated with or comprised in the data processor. According to some embodiments, the computer program may, when loaded into and run by the data processor, cause execution of method steps according to, for example, any of the methods illustrated in FIGS. 1-3, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1.-39. (canceled)

40. A method for suppression, at a first radio access node, of interference caused by other radio access nodes when the first radio access node and/or the other radio access nodes operate in a full duplex mode, wherein the full duplex mode comprises simultaneous transmission and reception in a same frequency interval, the method comprising:
acquiring measurements indicative of channel conditions between the other radio access nodes and the first radio access node, wherein channel conditions indicate interference caused at the first radio access node by the other radio access nodes;
selecting a set of radio access nodes from the other radio access nodes based on the channel conditions between the other radio access nodes and the first radio access node, wherein selecting the set of radio access nodes comprises one or more of:
selecting the set to comprise radio access nodes which cause highest interference at the first radio access node among the other radio access nodes;
selecting the set to comprise radio access nodes which cause interference at the first radio access node that exceeds an interference threshold;
selecting the set to comprise radio access nodes which cause an accumulated interference at the first radio access node that is a defined fraction of an accumulated interference at the first radio access node caused by all of the other radio access nodes; and
determining an uplink receive filter for suppression of interference at the first radio access node based on the channel conditions between the selected set of radio access nodes and the first radio access node.

41. The method according to claim 40, wherein determining the uplink receive filter for the first radio access node comprises selecting the uplink receive filter based on a null space defined by the channel conditions between the selected set of radio access nodes and the first radio access node.

42. The method according to claim 40, further comprising controlling one or more user devices served by the first radio access node to apply an uplink transmit beamforming which is based on the uplink receive filter.

43. The method according to claim 40, wherein acquiring measurements comprises performing the measurements.

44. The method according to claim 40, further comprising acquiring transmission particulars of the other radio access nodes, wherein selecting the set of radio access nodes is further based on the transmission particulars.

45. The method according to claim 40, wherein the channel conditions are indicative of an effective channel, wherein an impact of the effective channel corresponds to an impact of one or more of: transmitter imperfections, transmitter settings, propagation channel, interference, receiver settings, and receiver imperfections.

46. A method for a user device served by a first radio access node, wherein the first radio access node applies an uplink receive filter for suppression of interference caused by other radio access nodes when the first radio access node and/or the other radio access nodes operate in a full duplex mode, wherein the full duplex mode comprises simultaneous transmission and reception in a same frequency interval, wherein the uplink receive filter has been based on channel conditions between a set of radio access nodes and the first radio access node, wherein channel conditions indicate interference caused at the first radio access node by the other radio access nodes, the set of radio access nodes selected from the other radio access nodes based on the channel conditions between the other radio access nodes and the first radio access node, the method comprising:
receiving a control signal indicative of one or more of the uplink receive filter and an uplink transmit beamforming which is based on the uplink receive filter, wherein the control signal is indicative of the uplink receive filter; and
determining the uplink transmit beamforming based on the uplink receive filter, wherein determining the uplink transmit beamforming based on the uplink receive filter comprises selecting the uplink transmit beamforming such that a composite channel between the user device and the first radio access node fulfills a channel criterion, wherein the composite channel is defined by a combination of at least the uplink transmit beamforming, a propagation channel between the user device and the first radio access node, and the uplink receive filter.

47. The method according to claim 46, wherein the uplink transmit beamforming is selected as an eigenvector corresponding to a largest eigenvalue of a combination of the propagation channel between the user device and the first radio access node and the uplink receive filter.

48. The method according to claim 46, wherein determining the uplink transmit beamforming is further based on an interference condition.

49. The method according to claim 46, further comprising adjusting a power control setting based on the uplink receive filter and/or the uplink transmit beamforming.

50. An apparatus for suppression, at a first radio access node, of interference caused by other radio access nodes when the first radio access node and/or the other radio access nodes operate in a full duplex mode, wherein the full duplex mode comprises simultaneous transmission and reception in a same frequency interval, the apparatus comprising controlling circuitry configured to cause:
acquisition of measurements indicative of channel conditions between the other radio access nodes and the first radio access node, wherein channel conditions indicate interference caused at the first radio access node by the other radio access nodes;
selection of a set of radio access nodes from the other radio access nodes based on the channel conditions between the other radio access nodes and the first radio access node, wherein the controlling circuitry is configured to cause selection of the set of radio access nodes by causing one or more of:
selection of the set to comprise radio access nodes which cause highest interference at the first radio access node among the other radio access nodes;
selection of the set to comprise radio access nodes which cause interference at the first radio access node that exceeds an interference threshold;
selection of the set to comprise radio access nodes which cause an accumulated interference at the first radio access node that is a defined fraction of an accumulated interference at the first radio access node caused by all of the other radio access nodes; and
determination of an uplink receive filter for suppression of interference at the first radio access node based on the channel conditions between the selected set of radio access nodes and the first radio access node.

51. The apparatus according to claim 50, wherein the controlling circuitry is configured to cause determination of the uplink receive filter for the first radio access node by causing selection of the uplink receive filter based on a null space defined by the channel conditions between the selected set of radio access nodes and the first radio access node.

52. The apparatus according to claim 50, wherein the controlling circuitry is further configured to cause control of one or more user devices served by the first radio access node to apply an uplink transmit beamforming which is based on the uplink receive filter.

53. The apparatus according to claim 50, wherein the controlling circuitry is configured to cause acquisition of measurements by causing performance of the measurements.

54. The apparatus according to claim 50, wherein the controlling circuitry is further configured to cause acquisition of transmission particulars of the other radio access nodes, wherein selection of the set of radio access nodes is further based on the transmission particulars.

55. The apparatus according to claim 50, wherein the channel conditions are indicative of an effective channel, wherein an impact of the effective channel corresponds to an impact of one or more of: transmitter imperfections, transmitter settings, propagation channel, interference, receiver settings, and receiver imperfections.

56. An apparatus for a user device served by a first radio access node, wherein the first radio access node applies an uplink receive filter for suppression of interference caused by one or more other radio access nodes when the first radio access node and/or the other radio access nodes operate in a full duplex mode, wherein the full duplex mode comprises simultaneous transmission and reception in a same frequency interval, wherein the uplink receive filter has been based on channel conditions between a set of radio access nodes and the first radio access node, wherein channel conditions indicate interference caused at the first radio access node by the other radio access nodes, the set of radio access nodes selected from the other radio access nodes based on the channel conditions between the other radio access nodes and the first radio access node, the apparatus comprising controlling circuitry configured to cause:
reception of a control signal indicative of one or more of: the uplink receive filter and an uplink transmit beamforming which is based on the uplink receive filter, wherein the control signal is indicative of the uplink receive filter, and wherein the controlling circuitry is further configured to cause determination of the uplink transmit beamforming based on the uplink receive filter, wherein the controlling circuitry is configured to cause determination of the uplink transmit beamforming based on the uplink receive filter by causing selection of the uplink transmit beamforming such that a composite channel between the user device and the first radio access node fulfills a channel criterion, wherein the composite channel is defined by a combination of at least the uplink transmit beamforming, a propagation channel between the user device and the first radio access node, and the uplink receive filter.

57. The apparatus according to claim 56, wherein the controlling circuitry is configured to cause the uplink transmit beamforming to be selected as an eigenvector corresponding to a largest eigenvalue of a combination of the propagation channel between the user device and the first radio access node and the uplink receive filter.

58. The apparatus according to claim 56, wherein the controlling circuitry is configured to cause determination of the uplink transmit beamforming further based on an interference condition.

59. The apparatus according to claim 56, wherein the controlling circuitry is further configured to cause adjustment of a power control setting based on the uplink receive filter and/or the uplink transmit beamforming.
